(19) United States
(12) Patent Application Publication
(10) Pub. No.: US 2010/0097358 A1
(43) Pub. Date: Apr. 22, 2010

(54) DRIVE CIRCUIT FOR DISPLAY PANEL, DISPLAY PANEL MODULE, DISPLAY DEVICE, AND METHOD FOR DRIVING DISPLAY PANEL

(75) Inventor: Koji Totoki, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, TOKYO (JP)

(21) Appl. No.: 12/578,646

(22) Filed: Oct. 14, 2009

(30) Foreign Application Priority Data
Oct. 16, 2008 (JP) 2008-267217

(51) Int. Cl. G09G 5/00

(52) U.S. Cl. 345/204

(57) ABSTRACT

A drive circuit for a display panel includes a data driver unit for controlling an image display operation in a display panel, and a timing control unit for providing the data driver unit with signals necessary for the data driver unit to perform the control, the signals including at least a horizontal synchronizing signal, an image data signal for specifying content of the image to be displayed on the display panel, and a data driver control signal for specifying content of the control to be performed by the data driver unit. The image data signal and the data driver control signal are transmitted through the same signal line, with the data driver control signal being transmitted during a period in which the horizontal synchronizing signal is transmitted and the image data signal being transmitted during a period other than the period in which the horizontal synchronizing signal is transmitted.

### BACKGROUND OF THE INVENTION

1. Field of the Invention

The present invention relates to a drive circuit for a display panel which is configured to drive a display panel to display an image, a display panel module and a display device each provided with the display panel drive circuit, and a method for driving a display panel.

2. Description of the Related Art

Recently, display devices called “flat panel displays” have become widespread. A flat panel display is provided with a display panel such as a liquid crystal panel, an organic electroluminescence (EL) panel and the like, and is configured to display moving and/or still images using the display panel.

As shown in FIG. 10 for example, the flat panel display includes, in association with a display panel 51 for displaying images, a data driver unit 52 and a scan driver unit 53 for controlling the image display operations in the display panel 51, and a timing control unit 54 for supplying signals to the driver units 52 and 53. For an image to be displayed on the display panel 51, a clock signal CLK, a vertical synchronizing signal Vsync, a horizontal synchronizing signal Hsync, and an image data signal (for example, a signal of 30 bits in total, with 10 bits for each of the three colors of RGB) are supplied from the timing control unit 54 to the data driver unit 52.

For supplying the signals from the timing control unit 54 to the data driver unit 52, the image data signal and at least one of the vertical synchronizing signal Vsync and the horizontal synchronizing signal Hsync may be transmitted via the same signal line in a time-division multiplexed manner (see, for example, Japanese Unexamined Patent Application Publication No. 2006-259487). Transmitting the signals via the same signal line is advantageous in that, with a decreased number of signal lines, the device size as well as the noise can be reduced.

### SUMMARY OF THE INVENTION

In some flat panel displays, however, it is necessary to provide a data driver control signal to the data driver unit 52 in order for an image to be displayed on the display panel 51. That is, supply of the data driver control signal is necessary in addition to supply of the clock signal CLK, the vertical synchronizing signal Vsync, the horizontal synchronizing signal Hsync, and the image data signal.

The data driver control signal refers to a signal for specifying content of the control which is to be performed by the data driver unit 52. More specifically, the data driver control signal includes a signal for setting a current or voltage value in the data driver unit 52 so as to cause the data driver unit 52 to output the current or the voltage of that value to the display panel 51, and a signal for designating internal settings of the data driver unit 52.

This means that, in the case where it is necessary to supply the data driver control signal, even if the synchronizing signals Vsync, Hsync and the image data signal are multiplexed, another signal line for transmitting the data driver control signal will be necessary in addition to the signal line for transmitting the synchronizing signals and the image data signal. That is, it will be necessary to prepare a dedicated input terminal in the data driver unit 52, or to provide a dedicated interface circuit between the timing control unit 54 and the data driver unit 52, for transmission of the data driver control signal.

Such an increase in the number of signal lines and dedicated input terminals provided, as well as provision of the dedicated interface circuit, will result in a complicated circuit configuration and an increased device cost, which are desired to be prevented.

In view of the foregoing, it is desirable to provide a drive circuit for a display panel, a display panel module, a display device, and a method for driving a display panel which can reduce the number of signal lines provided between the timing control unit and the data driver unit, and also reduce the number of terminals in the data driver unit, in the case where a data driver control signal is to be transmitted.

According to an embodiment of the present invention, there is provided a drive circuit for a display panel, the drive circuit including: a data driver unit configured to control an image display operation in a display panel on which an image is displayed; and a timing control unit configured to provide the data driver unit with signals necessary for the data driver unit to perform the control, the signals including at least a horizontal synchronizing signal, an image data signal for specifying content of the image to be displayed on the display panel, and a data driver control signal for specifying content of the control to be performed by the data driver unit, wherein the image data signal and the data driver control signal are provided from the timing control unit to the data driver unit through the same signal line, with the data driver control signal being transmitted during a time period in which the horizontal synchronizing signal is transmitted and the image data signal being transmitted during a time period other than the time period in which the horizontal synchronizing signal is transmitted.

In the drive circuit for a display panel according to the embodiment described above, the data driver control signal is transmitted during the time period in which the horizontal synchronizing signal is transmitted, while the image data signal is transmitted during the time period in which no horizontal synchronizing signal is transmitted. In other words, the image data signal and the data driver control signal are supplied from the timing control unit to the data driver unit via the same signal line. Accordingly, even in the case where the data driver control signal for specifying the content of the control that is to be carried out by the data driver unit is transmitted from the timing control unit to the data driver unit, the number of signal lines provided between the timing control unit and the data driver unit as well as the number of terminals provided therefor can be decreased compared to the case where the image data signal and the data driver control signal are transmitted via separate signal lines. This can simplify the circuit configuration for connecting the timing control unit and the data driver unit, and facilitate reduction of the device size, whereby an increase in device cost can be suppressed. Moreover, when the data driver control signal is transmitted, the content of the data driver control signal can be changed so as to change the content of the control to be performed by the data driver unit. That is, the operating conditions and setting thereof can be changed considerably easily, ensuring highly versatile operation control.

### BRIEF DESCRIPTION OF THE DRAWINGS

FIG. 1 is a functional block diagram schematically illustrating a configuration of a display device according to an embodiment of the present invention;

FIG. 2 is a block diagram illustrating a functional configuration of a drive circuit for a display panel according to an embodiment of the present invention;

FIGS. 3A, 3B, and 3C are timing charts illustrating, by way of example, a method for driving a display panel according to an embodiment of the present invention;

FIG. 4 illustrates, by way of example, command assignment for a data driver control signal;

FIG. 5 is a perspective view of a television set as an example of an electronic apparatus;

FIGS. 6A and 6B are perspective views of a digital camera as another example of the electronic apparatus;

FIG. 7 is a perspective view of a notebook-sized personal computer as a further example of the electronic apparatus;

FIG. 8 is a perspective view of a video camera as yet another example of the electronic apparatus;

FIGS. 9A, 9B, 9C, 9D, 9E, 9F, and 9G show a mobile terminal device, e.g. a mobile phone, as yet another example of the electronic apparatus; and

FIG. 10 is a functional block diagram illustrating a configuration of a main part of a display device of the related art.

### DESCRIPTION OF THE PREFERRED EMBODIMENTS

Hereinafter, a drive circuit for a display panel, a display panel module, a display device, and a method for driving a display panel according to embodiments of the present invention will be described with reference to the drawings.

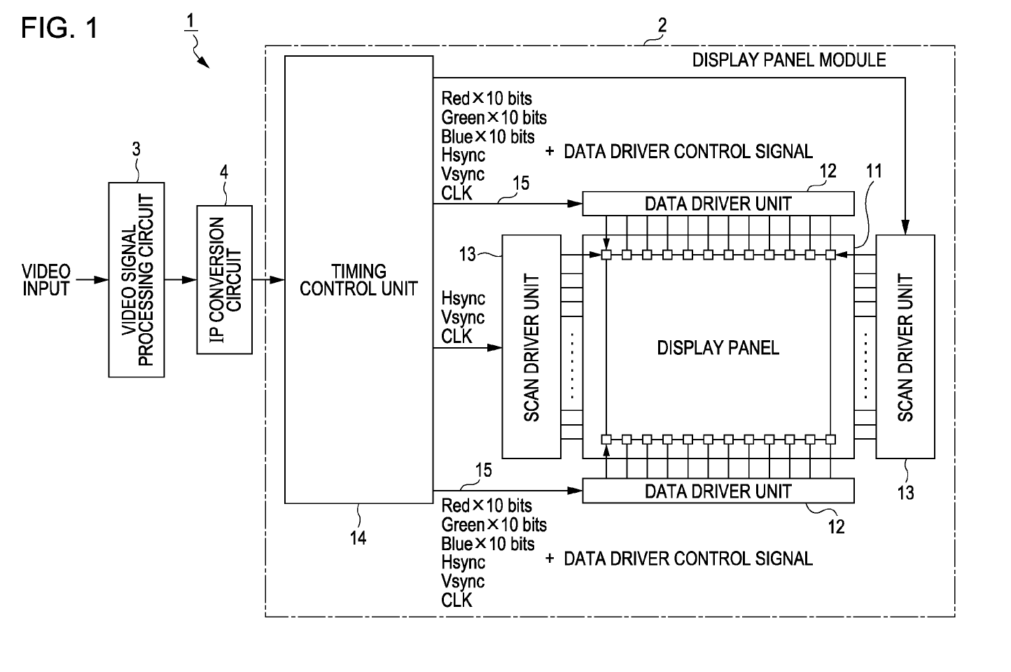

FIG. 1 is a functional block diagram schematically illustrating a configuration of a display device according to an embodiment of the present invention.

Referring to FIG. 1, a display device 1 includes a display panel module 2, a video signal processing circuit 3, and an IP conversion circuit 4. When the video signal processing circuit 3 receives a video signal from the outside, the video signal processing circuit 3 performs predetermined signal processing on the video signal as appropriate. Further, the IP conversion circuit 4 performs conversion from an interlace signal to a progressive signal, and passes the converted signal to a timing control unit 14 included in the display panel module 2. That is, in the display device 1, the video signal processing circuit 3 and the IP conversion circuit 4 function as a “signal processing unit” which is configured to pass an externally input video signal to the timing control unit 14.

The display panel module 2 includes a display panel 11, and a drive circuit for the display panel (hereinafter, also referred to as the “display panel drive circuit”) which is configured to drive the display panel 11 to display images.

The display panel 11 has a plurality of display elements arranged in a matrix. The display panel 11 uses the display elements to display images. The display elements may be spontaneous-luminescence organic EL elements, or may be transmissive or reflective liquid crystal elements. The display elements however are not limited thereto; they may be any other display elements (such as spontaneous-luminescence elements which emit light by electric discharge) as long as they can constitute a flat panel display.

The display panel drive circuit is configured to control the image display operations in the display panel 11 to cause the display panel 11 to display images. To this end, the display panel drive circuit includes a data driver unit 12, a scan driver unit 13, a timing control unit 14, and a signal line 15 through which signals are transmitted.

The data driver unit 12 causes the display panel 11 to display images by providing each display element constituting the display panel 11 with a voltage and current of a magnitude corresponding to the image data signal for specifying the content of the image to be displayed on the display panel 11. In the case where the display panel 11 is configured to receive a constant current at each display element, the data driver unit 12 performs gray scale display by pulse width modulation. That is, the data driver unit 12 controls the image display operations in the display panel 11 by supplying the voltage and current to each display element.

The scan driver unit 13, likewise the data driver unit 12, controls the image display operations in the display panel 11. The scan driver unit 13 is configured to perform line sequential scanning in synchronization with an output of the data driver unit 12.

The timing control unit 14 is configured to output various signals necessary for the image display in the display panel 11. The timing control unit 14 generates and supplies signals to the driver units 12 and 13. More specifically, the timing control unit 14 receives the video signal from the video signal processing circuit 3 and the IP conversion circuit 4, converts the transmission rate of the video signal so as to be synchronous with the display timing on the display panel 11, and provides the data driver unit 12 with the resultant signal as the image data signal for specifying the image display content in the display panel 11. Further, in order to specify the content of the control to be performed by the data driver unit 12, the timing control unit 14 generates a control signal in accordance with the specification of the data driver unit 12, and provides the data driver unit 12 with the resultant signal as a data driver control signal. Furthermore, the timing control unit 14 provides the data driver unit 12 with a clock signal CLK, a vertical synchronizing signal Vsync, and a horizontal synchronizing signal Hsync, as the synchronizing signals for the image data signal. That is, the timing control unit 14 is configured to provide the data driver unit 12 with at least the horizontal synchronizing signal Hsync, the image data signal (for example, a signal of 30 bits in total, with 10 bits for each of the three colors of RGB), and the data driver control signal, as the signals necessary for the data driver unit 12 to perform control.

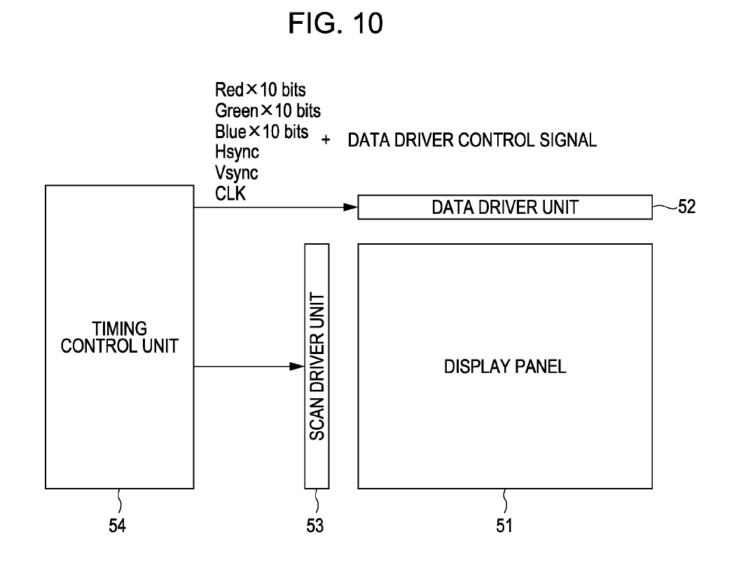

While the timing control unit 14 also supplies a signal to the scan driver unit 13, the content of the signal is similar to that of the related art (see, e.g., FIG. 10), and thus, description thereof will not be provided here.

The data driver unit 12 and the timing control unit 14 are structured as separate substrates. Thus, signal transmission between the data driver unit 12 and the timing control unit 14 is normally carried out using a high-speed data-multiplexed differential signal transmission system such as a low voltage differential signaling (LVDS) system or a reduced swing differential signaling (RSDS) system.

The signal line for use in such high-speed differential transmission is more expensive than an ordinary signal line. Thus, an increased number of signal lines will complicate the circuit configuration and also directly lead to an increased device cost.

In view of the foregoing, according to the display device 1, the display panel module 2, and the display panel drive circuit of the present embodiment, the data driver control signal and the image data signal are transmitted in a superimposed manner from the timing control unit 14 to the data driver unit 12. Transmitting the signals in such a superimposed manner can simplify the signal line 15 provided between the data driver unit 12 and the timing control unit 14.

A specific manner of superimposing the signals will now be described.

Firstly, an example of the functional configuration for transmitting the signals in a superimposed manner will be described.

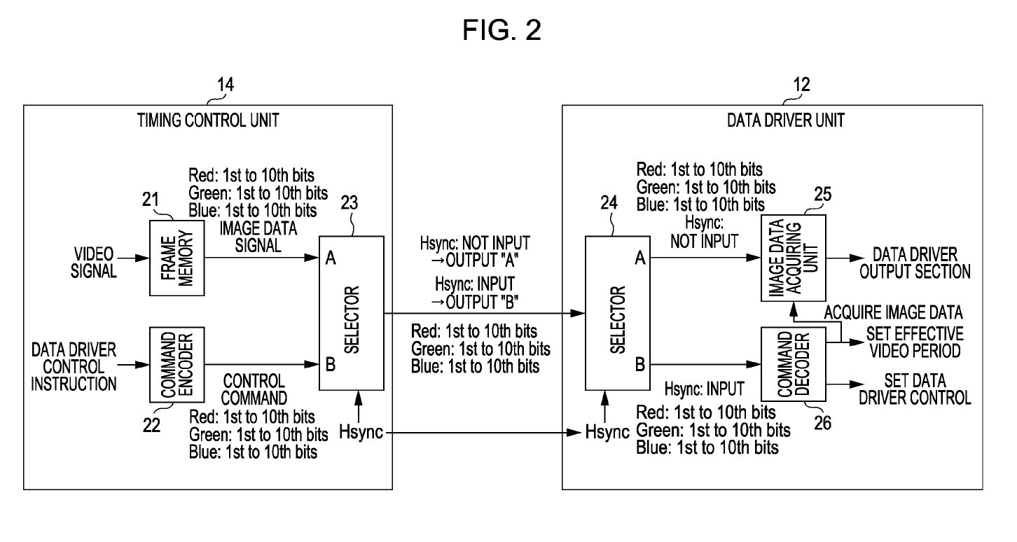

FIG. 2 is a block diagram illustrating, by way of example, the functional configuration of the display panel drive circuit according to an embodiment of the present invention.

Referring to FIG. 2, in the display panel drive circuit, the timing control unit 14, which serves as a signal transmission source, includes a frame memory 21, a command encoder 22, and a selector 23.

The frame memory 21 is configured to generate an image data signal at a transmission rate that is synchronized with the display timing in the display panel 11, on the basis of the video signal received from the video signal processing circuit 3 and the IP conversion circuit 4. The image data signal generated may be a signal of 30 bits in total, with 10 bits for each of the three colors of RGB. The signal however does not necessarily have to be a 30-bit signal; it may be a signal of any other form.

The command encoder 22 is configured to generate a control command, which will be the data driver control signal, in accordance with a data driver control instruction.

The data driver control instruction is for specifying the content of the control that is to be carried out by the data driver unit 12. The data driver control instruction is provided from the outside of the timing control unit 14 (e.g., from an upper-level circuit in the display panel drive circuit).

The control command is a command about the content of the control to be performed by the data driver unit 12, which is uniquely specified within the display panel drive circuit. More specifically, as will be described later in detail, the control command may be determined, e.g., by a combination of on and off states of 30 bits included in the signal which are assigned to the three colors of RGB. The data driver control signal is configured to include this control command which uniquely specifies the content of the control to be performed by the data driver unit 12.

That is, the command encoder 22 implements the encoding function to convert the data driver control instruction into a control command in accordance with the content of the control to be performed by the data driver unit 12. By performing this conversion into the control command, the command encoder 22 generates the data driver control signal for application to the data driver unit 12.

The selector 23 selectively supplies the image data signal, generated by the frame memory 21, and the data driver control signal, generated by the command encoder 22, to the data driver unit 12 via a common signal line 15. Specifically, the selector 23 transmits the signals in synchronization with the horizontal synchronizing signal Hsync in such a manner that the data driver control signal supplied from the command encoder 22 is transmitted during a period in which the horizontal synchronizing signal Hsync is transmitted, and that the image data signal supplied from the frame memory 21 is transmitted during a period in which no horizontal synchronizing signal Hsync is transmitted.

The data driver unit 12, which is the signal receiving side, includes a selector 24, an image data acquiring unit 25, and a command decoder 26.

The selector 24 discriminates the signals which have been transmitted from the timing control unit 14 in synchronization with the horizontal synchronizing signal Hsync. Specifically, the selector 24 determines that the signal which has been transmitted during the period in which no horizontal synchronizing signal Hsync has been transmitted is the image data signal, and passes the signal to the image data acquiring unit 25. The selector 24 determines that the signal which has been transmitted during the period in which the horizontal synchronizing signal Hsync has been transmitted is the data driver control signal, and passes the signal to the command decoder 26.

The image data acquiring unit 25 acquires the image data signal, and outputs the voltage and current of the magnitude corresponding to the image data signal to each display element in the display panel 11.

The command decoder 26 implements the decoding function to interpret the control command constituting the data driver control signal. The command decoder 26 determines the content of the control to be performed in the data driver unit 12 on the basis of the result of interpretation of the control command, and carries out the operation according to the determined content within the corresponding horizontal period.

An example of the process operation for transmitting the signals in a superimposed manner will now be described.

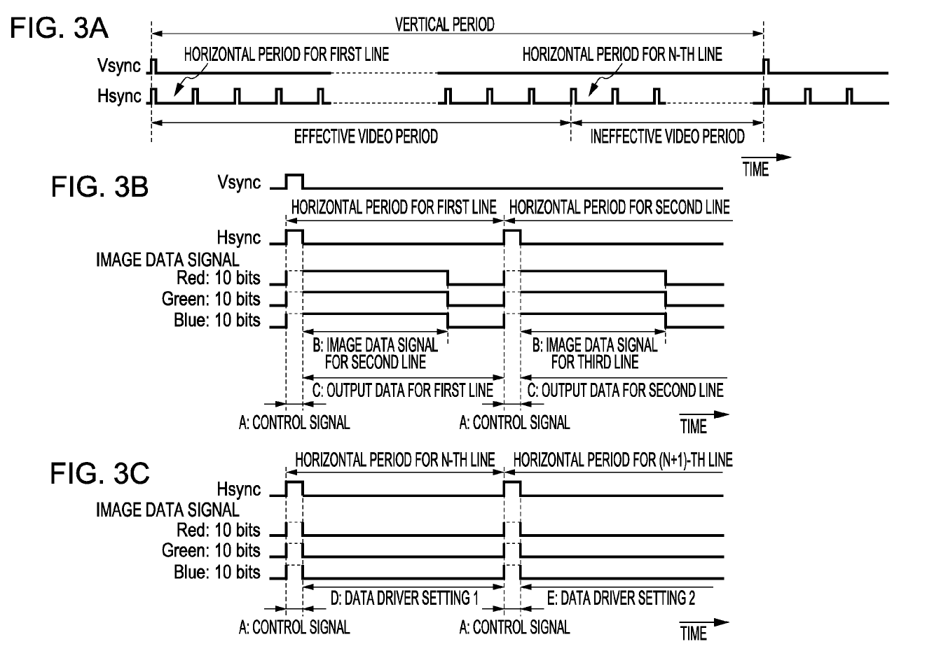

FIGS. 3A, 3B, and 3C are timing charts illustrating, by way of example, the process operation in the display panel drive circuit having the above-described configuration, i.e., the method for driving a display panel according to an embodiment of the present invention.

As shown in FIG. 3A, the display panel drive circuit drives and controls the display panel 11 in accordance with the timings specified by the vertical synchronizing signal Vsync and the horizontal synchronizing signal Hsync. Specifically, a vertical period specified by the vertical synchronizing signal Vsync includes horizontal periods for a plurality of lines specified by the horizontal synchronizing signal Hsync. Of these horizontal periods, those for the first to (N−1)th lines correspond to an effective video period, and those for the Nth and subsequent lines correspond to an ineffective video period. In the effective video period, the voltage and current of the magnitude according to the image data signal are supplied to each display element in the display panel 11 to cause the display panel 11 to display an image. In the ineffective video period, which corresponds to a so-called blanking period, no images are displayed on the display panel 11.

More specifically, in the effective video period, as shown in FIG. 3B, the data driver unit 12 performs the following process operations. During the horizontal period for the first line, for example, the data driver unit 12 outputs data for the first line to the display elements in the display panel 11, triggered by the falling edge of the horizontal synchronizing signal Hsync, which corresponds to one period of the clock signal CLK. The data driver unit 12 also acquires an image data signal for the second line from the timing control unit 14. Then, during the horizontal period for the second line, the data driver unit 12 outputs the data for the second line to the display elements in the display panel 11, again triggered by the falling edge of the horizontal synchronizing signal Hsync. The data driver unit 12 further acquires an image data signal for the third line from the timing control unit 14.

During the period in which the horizontal synchronizing signal Hsync is transmitted, i.e. during the period from the rising edge to the falling edge of the horizontal synchronizing signal Hsync, the data driver unit 12 outputs no data to the display elements and acquires no image data signal from the timing control unit 14. This is because, in the flat panel display, a signal format and driving timings similar to those used in a cathode ray tube (CRT) are used without modification.

As such, during the period in which the horizontal synchronizing signal Hsync is transmitted, the signal line 15 which is supposed to be used for transmitting the image data signal from the timing control unit 14 to the data driver unit 12 is not used for transmitting the image data signal.

Thus, with the method for driving a display panel according to the present embodiment, the period during which the horizontal synchronizing signal Hsync is transmitted is utilized for transmitting the data driver control signal from the timing control unit 14 to the data driver unit 12. That is, the data driver control signal is transmitted utilizing the signal line 15 which is then available. As the data driver control signal is superimposed during a transmission period in which the horizontal synchronizing signal Hsync for each line is transmitted, the superimposed data driver control signal can specify the content of the control to be performed during the horizontal period following that transmission period. Further, as the signals are superimposed in synchronization with the horizontal synchronizing signals Hsync for the respective lines, the image data signal and the data driver control signal can be supplied from the timing control unit 14 to the data driver unit 12 through the same signal line 15.

In order for those signals to be transmitted using the same signal line 15, it is necessary that the signals are temporally separated from each other. There is no problem in this regard, because the data driver control signal is transmitted during the period in which the horizontal synchronizing signal Hsync is transmitted, while the image data signal is transmitted following the transmission of (i.e., after falling of) the horizontal synchronizing signal Hsync.

Transmitting the signals in a superimposed manner as described above is advantageous in the following points. During the effective video period, the data driver control signal superimposed in synchronization with the horizontal synchronizing signal Hsync clearly indicates that the horizontal period following that horizontal synchronizing signal Hsync is within the effective video period. In response thereto, as shown in FIG. 3B, the data driver unit 12 can perform output (i.e., data output) of the voltage and current according to the image data signal, and acquisition (i.e., data acquisition) of the image data signal for the next horizontal period, as described above.

Further, during the ineffective video period, as shown in FIG. 3C, the data driver unit 12 does not output the voltage or current according to the image data signal. Rather, the data driver control signal superimposed in synchronization with the horizontal synchronizing signal Hsync indicates the content of the control operation that is supposed to be performed during the horizontal period following that horizontal synchronizing signal Hsync. Accordingly, the data driver unit 12 performs the control operation of the content indicated by the data driver control signal, during the horizontal period following that horizontal synchronizing signal Hsync.

The content of the control that is to be performed by the data driver unit 12 may include: setting of a constant current value in the case where the data driver unit 12 is configured to output a constant current to the display panel 11; an on/off instruction of the reset operation for the settings in the data driver unit 12; switching between on and off of the output stage of the data driver unit 12; switching between interlace and progressive of the display image; management of information about odd-numbered frames and even-numbered frames of the display image; and management of the horizontal line numbers, although the content of the control is not restricted thereto.

A specific example of the data driver control signal for specifying the content of the control to be performed in the data driver unit 12 will now be described.

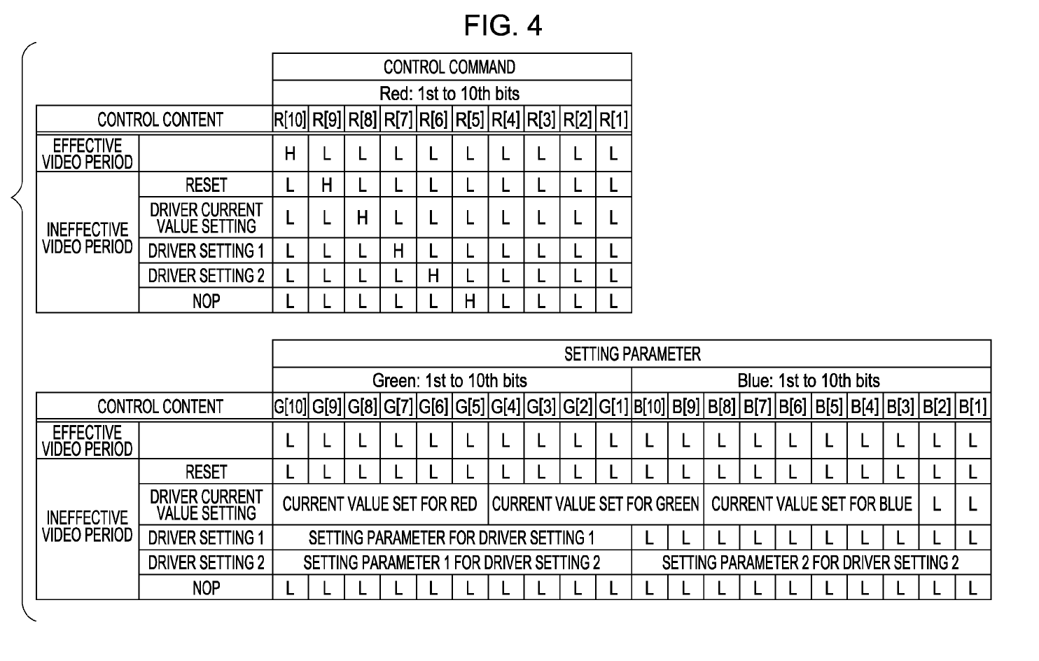

FIG. 4 illustrates, by way of example, command assignment for the data driver control signal.

In the example shown in FIG. 4, a command is assigned to the image data signal of 30 bits in total, with 10 bits for each of the three colors of RGB. More specifically, the control command for specifying the content of the control to be performed in the data driver unit 12 is assigned to the first to tenth bits of the R color in the signal. In this case, a combination of high (on) and low (off) states of those bits defines the content of the control to be performed in the data driver unit 12. On the other hand, setting parameters associated with the control command are assigned to the 20 bits for the G and B colors in the signal. The setting parameters necessary for the control operations in the data driver unit 12 are defined by binary numbers using the high (on) and low (off) states of those bits. Although the control command is assigned to the bits for the R color and the setting parameters for the control are assigned to the bits for the G and B colors in this example, the manner of assigning commands to signals is not restricted thereto; it may be set in any arbitrary way.

The way of assigning commands to signals may be set in advance and held in the form of a table, as shown in FIG. 4 for example, within the timing control unit 14 and the data driver unit 12, or in a storage that can be accessed by the timing control unit 14 and the data driver unit 12.

When the data driver control signal which has been configured on the basis of the command assignment as described above is received from the timing control unit 14, the data driver unit 12 performs the process operations as follows. Firstly, the data driver unit 12 recognizes whether the first bit of the R color in the signal is high (on) or low (off). If the recognized result is high, the data driver unit 12 determines that it is within the effective video period, and during the horizontal period following the horizontal synchronizing signal Hsync, outputs data according to the image data signal and acquires data for the next horizontal period. On the other hand, if the recognized result is low, the data driver unit 12 determines that it is within the ineffective video period, and further recognizes whether the second through fifth bits of the R color in the signal are high (on) or low (off), in order to determine whether the content of the control to be performed is a reset operation, driver current value setting operation, driver setting 1, driver setting 2, or NOP (no operation). The data driver unit 12 then performs the control of the content that has been determined to be performed, during the horizontal period following the horizontal synchronizing signal Hsync, in accordance with the setting parameters that have been specified in the 20 bits for the G and B colors in the signal. The contents of the driver setting 1 and the driver setting 2 in this example are not specifically restricted. That is, the driver setting 1 and the driver setting 2 are only the names for identification of the control contents to be performed by the data driver unit 12. They may represent, e.g., switching between on and off of the output stage of the data driver unit 12, switching between interlace and progressive of the display image, management of the information about the odd-numbered frames and the even-numbered frames in the display image, or management of the horizontal line numbers.

As described above, according to the display device 1, the display panel module 2, and the display panel drive circuit, and according to the method for driving the display panel 11 performed by the display panel drive circuit of the embodiments of the present invention, the image data signal and the data driver control signal are supplied from the timing control unit 14 to the data driver unit 12 through the same signal line 15. Thus, compared to the case where the image data signal and the data driver control signal are transmitted via separate signal lines from the timing control unit 14 to the data driver unit 12, the number of signal lines and the number of terminals provided therefor can be decreased. That is, even in the where the data driver control signal for specifying the content of the control to be performed by the data driver unit 12 is transmitted from the timing control unit 14 to the data driver unit 12, the number of signal lines provided between the timing control unit 14 and the data driver unit 12 as well as the number of terminals provided therefor can be decreased. This can simplify the circuit configuration for connecting the timing control unit 14 and the data driver unit 12, and facilitate reduction in size of the device, so that an increase in device cost can be suppressed. Furthermore, when the data driver control signal is transmitted, the content of the data driver control signal can be changed so as to change the content of the control to be performed by the data driver unit 12. That is, the operating conditions and setting thereof can be changed considerably easily, ensuring highly versatile operation control.

Furthermore, when the data driver control signal is configured to include the control command which uniquely specifies the content of the control to be performed in the data driver unit 12, as described in the above embodiment, the control content can be expressed by a combination of on and off states of bits in the signal. That is, the data driver control signal can be configured in the signal format similar to that of the image data signal. This is considerably convenient for transmitting the image data signal and the data driver control signal through the same signal line 15. Moreover, this can facilitate configuration of the data driver control signal so as to include not only the control command but also the setting parameters associated with the control command. Accordingly, the control command and the setting parameters can be transmitted at the same time, which can advantageously improve the signal transmission efficiency.

Furthermore, when the timing control unit 14 is provided with the command encoder 22 having the encoding function and the data driver unit 12 is provided with the command decoder 26 having the decoding function, as described in the above embodiment, the data driver control signal including the control command can be transmitted from the timing control unit 14 to the data driver unit 12, irrespective of the format of the signal being supplied from the outside.

Furthermore, when the content of the control to be specified by the control command is differentiated in the effective video period and in the ineffective video period during one vertical period, as described in the above embodiment, even if the data driver control signal is transmitted during the period in which the horizontal synchronizing signal Hsync is transmitted, there will be no adverse effects on the image display operation in the display panel 11 during the effective video period. That is, the control content specified by the control command may be restricted such that the image display operation based on the image data signal is designated during the effective video period and the driver internal setting for the data driver unit 12 is designated during the ineffective video period. In this manner, the process operations in the data driver unit 12 can be clearly switched between those during the effective video period and those during the ineffective video period.

While the example of switching the control between the effective video period and the ineffective video period has been described above, the control may also be switched in the following manner.

The control functions specified by the control command may be differentiated in the following manner, and the control may be enabled within the horizontal period during which the data driver control signal has been transmitted, to cause the data driver unit 12 to operate under that control. Specifically, the operations to be performed during the effective video period may include the data output operation according to the image data signal and the operation of acquiring the image data signal for the next horizontal period. The operations to be performed in a driver control period during the ineffective video period may include the driver internal setting operation, but not include the data output operation. Further, the operations to be performed in a driver non-control period during the ineffective video period may include neither the data output operation nor the driver internal setting operation. That is, during the ineffective video period, the control content specified by the control command may include the driver internal setting operation in the data driver unit 12, and the standby operation during which neither the image display operation nor the internal setting operation is performed.

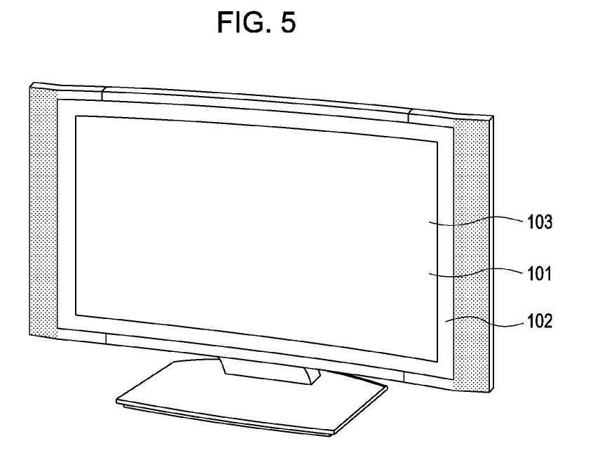

The display device 1 configured to include the display panel drive circuit or the display panel module 2 as described above may be used for various electronic apparatuses as shown in FIGS. 5 to 9G. Hereinafter, examples of the electronic apparatuses for which the display device may be used will be described.

FIG. 5 is a perspective view of a television set which is a specific example of the electronic apparatus. The television set shown in FIG. 5 includes a video display screen unit 101 which is made up primarily of a front panel 102 and a filter glass 103, and is manufactured by using an organic EL display device for the video display screen unit 101.

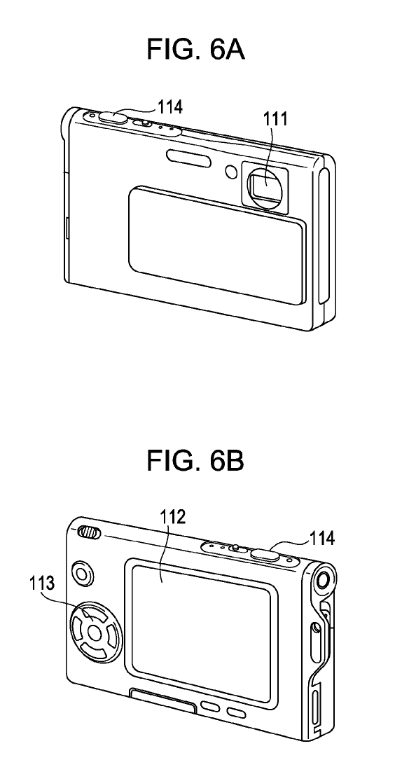

FIGS. 6A and 6B are perspective views, as seen from the front side and the rear side, respectively, of a digital camera which is another specific example of the electronic apparatus. The digital camera shown includes a light emitting unit 111 for flashing, a display unit 112, a menu switch 113, and a shutter button 114, and is manufactured by using an organic EL display device for the display unit 112.

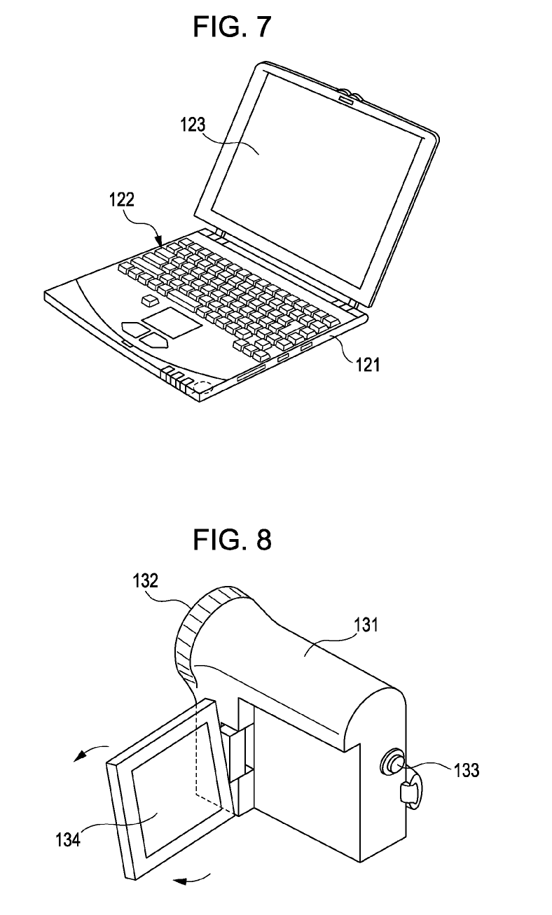

FIG. 7 is a perspective view of a notebook-sized personal computer which is a further example of the electronic apparatus. The notebook-sized personal computer shown includes a body 121, and the body 121 includes a keyboard 122 for use in inputting characters and a display unit 123 for displaying images. The notebook-sized personal computer is manufactured by using an organic EL display device for the display unit 123.

FIG. 8 is a perspective view of a video camera which is yet another example of the electronic apparatus. The video camera shown includes a body unit 131, a lens 132 for shooting an object provided on a side facing frontward, a start/stop switch 133 used in shooting, and a display unit 134. The video camera is manufactured by using an organic EL display device for the display unit 134.

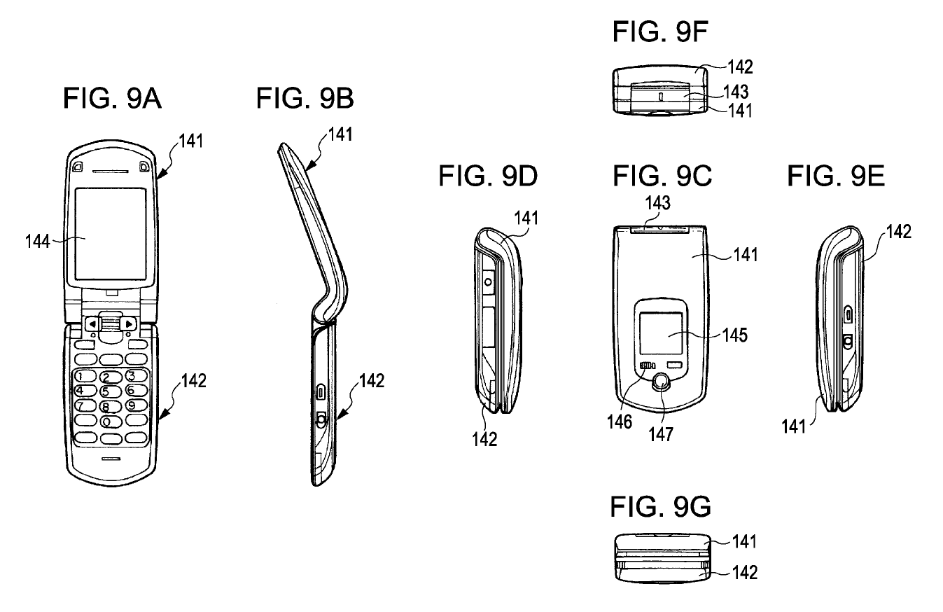

FIGS. 9A, 9B, 9C, 9D, 9E, 9F, and 9G show a mobile terminal device, e.g. a mobile phone, as yet another example of the electronic apparatus, where FIG. 9A shows a front view when the mobile phone is open, FIG. 9B shows a side view, FIG. 9C shows a front view when the mobile phone is closed, FIG. 9D is a left side view, FIG. 9E is a right side view, FIG. 9F is a top plan view, and FIG. 9G is a bottom plan view. The mobile phone according to this example includes an upper casing 141, a lower casing 142, a connecting unit (here, a hinge unit) 143, a display 144, a sub display 145, a photographic light source 146, and a camera 147, and is manufactured by using organic EL display devices for the display 144 and the sub display 145.

The present application contains subject matter related to that disclosed in Japanese Priority Patent Application JP 2008-267217 filed in the Japan Patent Office on Oct. 16, 2008, the entire content of which is hereby incorporated by reference.

While the suitable examples of the present invention have been described in the embodiments, it should be understood by those skilled in the art that the present invention is not restricted to the content of the embodiments, but may be modified as appropriate within the scope of the present invention. For example, the number of bits constituting the signal illustrated in the above embodiments is not particularly restricted; it may be changed as appropriate.

What is claimed is:

1. A drive circuit for a display panel, comprising:
a data driver unit configured to control an image display operation in a display panel on which an image is displayed; and
a timing control unit configured to provide the data driver unit with signals necessary for the data driver unit to perform the control, the signals including at least a horizontal synchronizing signal, an image data signal for specifying content of the image to be displayed on the display panel, and a data driver control signal for specifying content of the control to be performed by the data driver unit,
the image data signal and the data driver control signal being provided from the timing control unit to the data driver unit through the same signal line, the data driver control signal being transmitted during a time period in which the horizontal synchronizing signal is transmitted, the image data signal being transmitted during a time period other than the time period in which the horizontal synchronizing signal is transmitted.

2. The drive circuit for a display panel according to claim 1, wherein the data driver control signal includes a control command, the control command uniquely specifying the content of the control to be performed by the data driver unit.

3. The drive circuit for a display panel according to claim 2, wherein
the timing control unit has an encoding function to perform conversion into the control command in accordance with the content of the control to be performed by the data driver unit, and
the data driver unit has a decoding function to interpret the control command.

4. The drive circuit for a display panel according to claim 2 or 3, wherein
the content of the control specified by the control command during an effective video period in a vertical period differs from the content of the control specified by the control command during an ineffective video period in the vertical period,
the content of the control specified during the effective video period including content designating an image display operation based on the image data signal,
the content of the control specified during the ineffective video period including content designating a driver internal setting operation in the data driver unit and content designating a standby operation in which neither the image display operation nor the internal setting operation is performed.

5. A display panel module comprising:
a display panel on which an image is displayed;
a data driver unit configured to control an image display operation in the display panel; and
a timing control unit configured to provide the data driver unit with signals necessary for the data driver unit to perform the control, the signals including at least a horizontal synchronizing signal, an image data signal for specifying content of the image to be displayed on the display panel, and a data driver control signal for specifying content of the control to be performed by the data driver unit,
the image data signal and the data driver control signal being provided from the timing control unit to the data driver unit through the same signal line, the data driver control signal being transmitted during a time period in which the horizontal synchronizing signal is transmitted, the image data signal being transmitted during a time period other than the time period in which the horizontal synchronizing signal is transmitted.

6. The display panel module according to claim 5, wherein the data driver control signal includes a control command, the control command uniquely specifying the content of the control to be performed by the data driver unit.

7. The display panel module according to claim 6, wherein
the timing control unit has an encoding function to perform conversion into the control command in accordance with the content of the control to be performed by the data driver unit, and
the data driver unit has a decoding function to interpret the control command.

8. The display panel module according to claim 6 or 7, wherein
the content of the control specified by the control command during an effective video period in a vertical period differs from the content of the control specified by the control command during an ineffective video period in the vertical period,
the content of the control specified during the effective video period including content designating an image display operation based on the image data signal,
the content of the control specified during the ineffective video period including content designating a driver internal setting operation in the data driver unit and content designating a standby operation in which neither the image display operation nor the internal setting operation is performed.

9. A display device comprising:
a display panel on which an image is displayed;
a data driver unit configured to control an image display operation in the display panel;
a timing control unit configured to provide the data driver unit with signals necessary for the data driver unit to perform the control, the signals including at least a horizontal synchronizing signal, an image data signal for specifying content of the image to be displayed on the display panel, and a data driver control signal for specifying content of the control to be performed by the data driver unit; and
a signal processing unit configured to pass an externally input video signal to the timing control unit;
the image data signal and the data driver control signal being provided from the timing control unit to the data driver unit through the same signal line, the data driver control signal being transmitted during a time period in which the horizontal synchronizing signal is transmitted, the image data signal being transmitted during a time period other than the time period in which the horizontal synchronizing signal is transmitted.

10. The display device according to claim 9, wherein the data driver control signal includes a control command, the control command uniquely specifying the content of the control to be performed by the data driver unit.

11. The display device according to claim 10, wherein
the timing control unit has an encoding function to perform conversion into the control command in accordance with the content of the control to be performed by the data driver unit, and
the data driver unit has a decoding function to interpret the control command.

12. The display device according to claim 10 or 11, wherein
the content of the control specified by the control command during an effective video period in a vertical period differs from the content of the control specified by the control command during an ineffective video period in the vertical period,
the content of the control specified during the effective video period including content designating an image display operation based on the image data signal,
the content of the control specified during the ineffective video period including content designating a driver internal setting operation in the data driver unit and content designating a standby operation in which neither the image display operation nor the internal setting operation is performed.

13. A method for driving a display panel, comprising a step of supplying signals from a timing control unit to a data driver unit, the data driver unit being configured to control an image display operation in a display panel on which an image is displayed, the timing control unit being connected to the data driver unit, the signals being necessary for the data driver unit to perform the control, the signals including at least a horizontal synchronizing signal, an image data signal for specifying content of the image to be displayed on the display panel, and a data driver control signal for specifying content of the control to be performed by the data driver unit,
the step of supplying signals including a step of supplying the image data signal and the data driver control signal from the timing control unit to the data driver unit through the same signal line, by transmitting the data driver control signal during a time period in which the horizontal synchronizing signal is transmitted and transmitting the image data signal during a time period other than the time period in which the horizontal synchronizing signal is transmitted.

14. The method for driving a display panel according to claim 13, wherein the data driver control signal includes a control command, the control command uniquely specifying the content of the control to be performed by the data driver unit.

15. The method for driving a display panel according to claim 14, wherein
the timing control unit has an encoding function to perform conversion into the control command in accordance with the content of the control to be performed by the data driver unit, and
the data driver unit has a decoding function to interpret the control command.

16. The method for driving a display panel according to claim 14 or 15, wherein
the content of the control specified by the control command during an effective video period in a vertical period differs from the content of the control specified by the control command during an ineffective video period in the vertical period,
the content of the control specified during the effective video period including content designating an image display operation based on the image data signal,
the content of the control specified during the ineffective video period including content designating a driver internal setting operation in the data driver unit and content designating a standby operation in which neither the image display operation nor the internal setting operation is performed.
